(19) United States
(12) Patent Application Publication
(10) Pub. No.: US 2025/0061413 A1
(43) Pub. Date: Feb. 20, 2025

(54) Food Item Tracking Device

(71) Applicant: Dave Bellot, Missouri City, TX (US)

(72) Inventor: Dave Bellot, Missouri City, TX (US)

(21) Appl. No.: 18/233,678

(22) Filed: Aug. 14, 2023

(51) Int. Cl. G06Q 10/087; G06K 7/10; G06K 19/06

(52) U.S. Cl. CPC G06Q 10/087; G06K 7/10821; G06K 19/06028

(57) ABSTRACT

A food item tracking device includes a plurality of scanners to scan a barcode of a food item being removed from a refrigerator or a pantry. Each of the plurality of scanners has a communication unit is in remote communication with an extrinsic communication network. A plurality of personal electronic devices is in remote communication with the extrinsic communication network such that each of the plurality of personal electronic devices receives the identity and the shelf life of the food item scanned by a respective scanner. Each of the plurality of personal electronic devices storing an analysis program to track the shelf life of each of the food items that are stored in the refrigerator and the pantry. Furthermore, the analysis program generates an alert when the analysis program associated with each of the plurality of personal electronic devices determines that a shelf life has expired.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking devices and more particularly pertains to a new tracking device for tracking the shelf life of food items stored in a refrigerator or a pantry. The device includes a plurality of scanners that are mounted in a refrigerator and a pantry for scanning barcodes of food items that are placed in the refrigerator and pantry. The device includes a plurality of electronic devices that each stores an analysis program for analyzing the expiration date of each food item that is scanned and generates an alert when any of the food items has expired.

### (2) Description of Related Art Including Information Disclosed Under 37 CFR 1.97 and 1.98

The prior art relates to tracking devices including a variety of inventory management devices for managing food items in a refrigerator that each at least includes a radio frequency identification reader for remotely reading an RFID tag on food items placed in a refrigerator and a food tracking device that includes a refrigerator that has a barcode scanner for compiling a list of food items stored in the refrigerator. In no instance does the prior art disclose a food inventory tracking device that includes bar code scanners that can be retrofitted into a refrigerator and a plurality of electronic devices that each stores an analysis program and which is in remote communication with the bar code scanners to generate an alert when a food item has expired.

### BRIEF SUMMARY OF THE INVENTION

An embodiment of the disclosure meets the needs presented above by generally comprising a plurality of scanners to scan a barcode of a food item being removed from a refrigerator or a pantry. Each of the plurality of scanners has a communication unit is in remote communication with an extrinsic communication network. A plurality of personal electronic devices is in remote communication with the extrinsic communication network such that each of the plurality of personal electronic devices receives the identity and the shelf life of the food item scanned by a respective scanner. Each of the plurality of personal electronic devices storing an analysis program to track the shelf life of each of the food items that are stored in the refrigerator and the pantry. Furthermore, the analysis program generates an alert when the analysis program associated with each of the plurality of personal electronic devices determines that a shelf life has expired.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a food item tracking device according to an embodiment of the disclosure.

FIG. 2 is a top perspective view of a scanner of an embodiment of the disclosure.

FIG. 3 is a bottom perspective view of a scanner of an embodiment of the disclosure.

FIG. 4 is a front phantom view of an embodiment of the disclosure.

FIG. 5 is a perspective in-use view of an embodiment of the disclosure showing a food item being positioned in a refrigerator.

FIG. 6 is a perspective in-use view of an embodiment of the disclosure showing a scanner reading a barcode on a food item.

FIG. 7 is a perspective in-use view of an embodiment of the disclosure showing a scanner being mounted in a pantry.

### DETAILED DESCRIPTION OF THE INVENTION

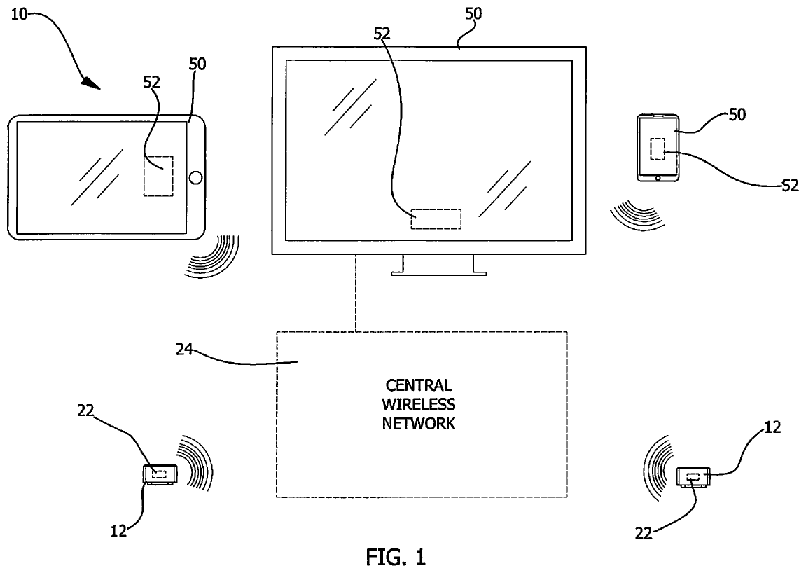

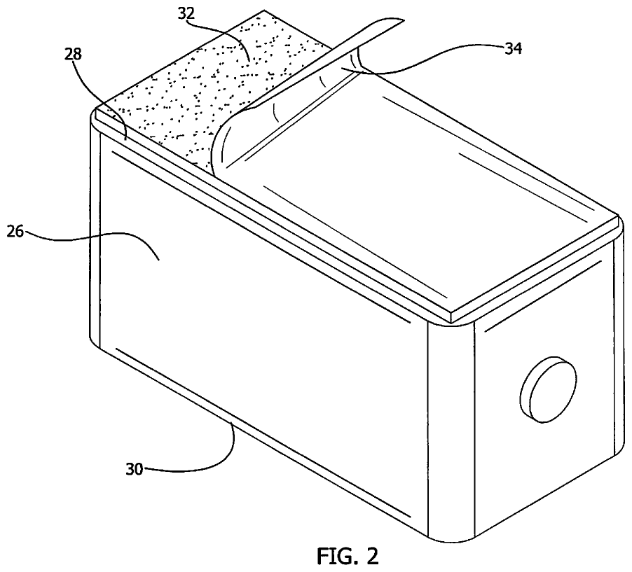

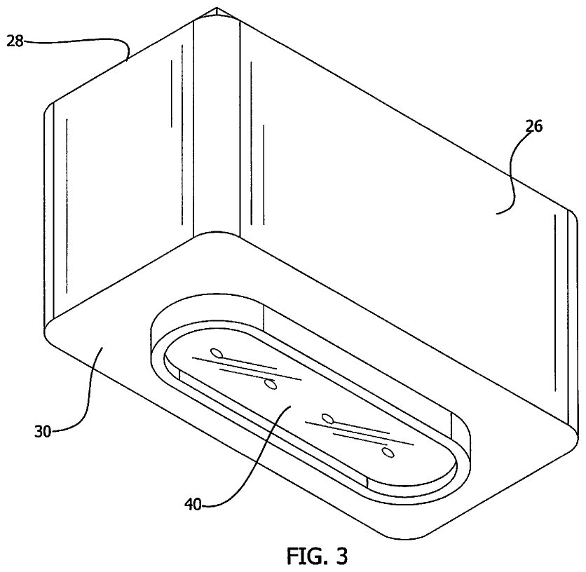

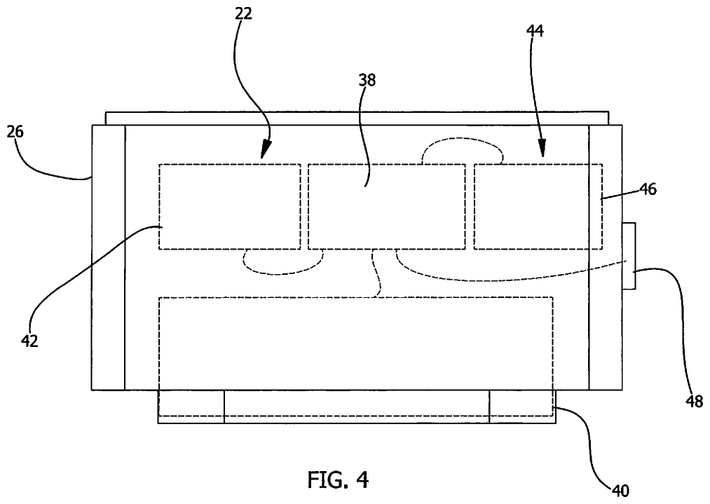

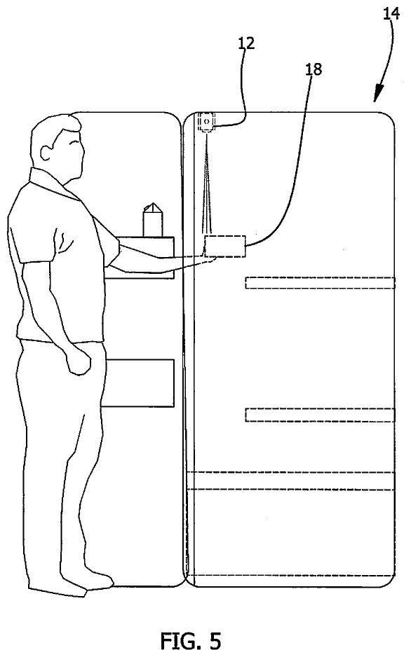

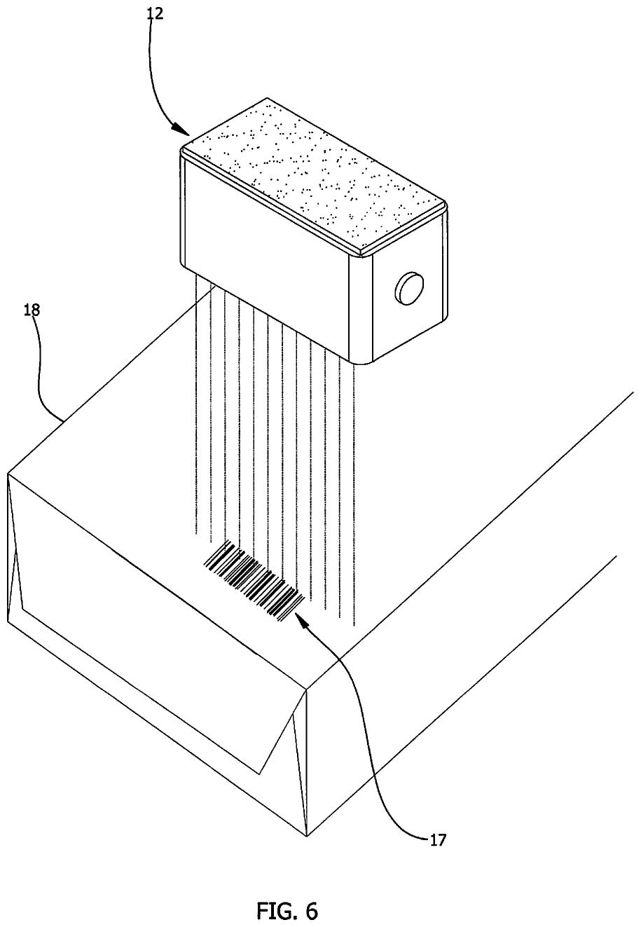

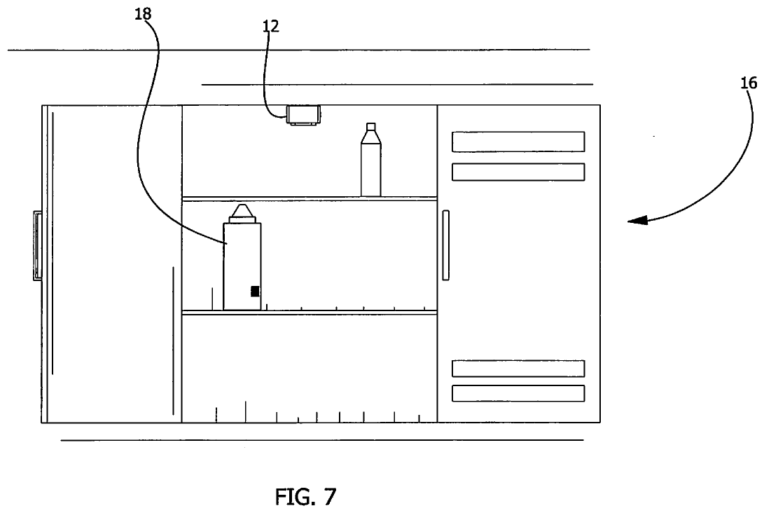

With reference now to the drawings, and in particular to FIGS. 1 through 7 thereof, a new tracking device embodying the principles and concepts of an embodiment of the disclosure and generally designated by the reference numeral 10 will be described.

As best illustrated in FIGS. 1 through 7, the food item tracking device 10 generally comprises a plurality of scanners 12 that is each mountable in a respective one of a refrigerator 14 and a pantry 16 to scan a barcode 17 of a food item 18 that is being removed from the refrigerator 14 or the pantry 16. The food item 18 may be any package food item that is perishable. Each of the plurality of scanners 12 has a communication unit 22 that is in remote communication with an extrinsic communication network 24 thereby facilitating each of the scanners 12 to broadcast data to the extrinsic communication network 24. In this way each of the scanners 12 broadcasts the shelf life of the food item 18 to the extrinsic communication network 24. The extrinsic communication network 24 may be the internet, a cellular phone network or any other type of wireless global communication network. Furthermore, the refrigerator 14 and the pantry 16 may be of any conventional design that might commonly be found in a residential dwelling.

Each of the plurality of scanners 12 comprises a housing 26 that has a top wall 28 and a bottom wall 30. Each of the scanners 12 includes an adhesive layer 32 that is applied to the top wall 28 thereby facilitating the adhesive layer 32 to adhere to the refrigerator 14 or the pantry 16 for attaching the housing 26 to the refrigerator 14 or the pantry 16. Each of the scanners 12 includes a protective sheet 34 that is removably applied to an exposed surface 36 of the adhesive layer 32 such that the protective sheet 34 inhibits the adhesive layer 32 from is adhered. Each of the scanners 12 includes a processor 38 that is integrated into the housing 26. Additionally, each of the scanners 12 includes a barcode reader 40 that is integrated into the bottom wall 30 of the housing 26 which emits infra-red light for reading a barcode 17 and the barcode reader 40 is electrically coupled to the processor 38.

Each of the scanners 12 includes a transmitter 42 that is integrated into the housing 26 such that the transmitter 42 defies the communication unit 22 and the transmitter 42 is electrically coupled to the processor 38. The transmitter 42 is in wireless communication with the extrinsic communication network 24 and the transmitter 42 receives data from the barcode reader 40 thereby facilitating the transmitter 42 to broadcast the data to the extrinsic communication network 24. The transmitter 42 associated with each of the scanners 12 may comprise a radio frequency transmitter or the like and the transmitter 42 associated with each of the scanners 12 may employ a WPAN signal.

Each of the scanners 12 includes a power supply 44 that is integrated into the housing 26 and the power supply 44 is electrically coupled to the processor 38. The power supply 44 comprises a battery 46 that is positioned within the housing 26 and the battery 46 is electrically coupled to the processor 38. The power supply 44 includes a power button 48 that is movably integrated into the housing 26 and the power button 48 is electrically coupled to the processor 38 for actuating and de-actuating the processor 38 when the power button 48 is depressed.

A plurality of personal electronic devices 50 is included and each of the plurality of personal electronic devices 50 is in remote communication with the extrinsic communication network 24. In this way each of the plurality of personal electronic devices 50 receives data from the extrinsic communication network 24 to receive the identity and the shelf life of the food item 18 scanned by a respective scanner 12. Each of the plurality of personal electronic devices 50 stores an analysis program 52 and a database which comprises data received from the extrinsic communication network 24. In this way each of the plurality of personal electronic devices 50 can store a list of all of the food items 18 that are stored in the refrigerator 14 and the pantry 16 and the shelf life of each of the food items 18. The plurality of personal electronic devices 50 may include a smartphone, a tablet, a personal computer and any other type of electronic device that has wireless communication capabilities and data storage capabilities. Additionally, the analysis program 52 associated with each of the personal electronic devices 50 may be a proprietary program developed specifically to work with the plurality of scanners 12 and to extract expiration date information from the data gained from the barcode 17.

The analysis program 52 associated with each of the plurality of personal electronic devices 50 analyzes data received from the extrinsic communication network 24. In this way each of the plurality of personal electronic devices 50 can track the shelf life of each of the food items 18 that are stored in the refrigerator 14 and the pantry 16. Furthermore, the analysis program 52 associated with each of the plurality of personal electronic devices 50 generates an alert when the analysis program 52 associated with each of the plurality of personal electronic devices 50 determines that a shelf life has expired. In this way the plurality of personal electronic devices 50 can notify a user that a food item 18 has expired.

In use, each of the plurality of scanners 12 is mounted in the refrigerator 14 or the pantry 16 and each food item 18 that is stored in either the refrigerator 14 or the pantry 16 is initially scanned with a respective scanner 12. In this way the identity of the food item 18 and the expiration date of the food item 18 is downloaded into the analysis program 52 in each of the plurality of personal electronic devices 50. Furthermore, the food item 18 is scanned each time the food item 18 is removed from the refrigerator 14 or the pantry 16 for use. The analysis program 52 in each of the plurality of personal electronic devices 50 generates an alert when the expiration date of any of the food items 18 has passed. In this way the user is notified that the food item 18 has expired and should be replaced.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food item tracking device for tracking the shelf life of food items being stored in a refrigerator or pantry, said device comprising:
a plurality of scanners, each of said plurality of scanners being mountable in a respective one of a refrigerator and a pantry wherein each of said plurality of scanners is configured to scan a barcode of a food item being removed from said refrigerator or said pantry, each of said plurality of scanners having a communication unit being in remote communication with an extrinsic communication network thereby facilitating each of said scanners to broadcast data to said extrinsic communication network wherein each of said scanners is configured to broadcast the shelf life of the food item to said extrinsic communication network;
a plurality of personal electronic devices, each of said plurality of personal electronic devices being in remote communication with said extrinsic communication network such that each of said plurality of personal electronic devices receives data from said extrinsic communication network wherein each of said personal electronic devices is configured to receive the identity and the shelf life of the food item scanned by a respective scanner, each of said plurality of personal electronic devices storing an analysis program and a database which comprises data received from said extrinsic communication network wherein each of said plurality of personal electronic devices is configured to store a list of all of the food items that are stored in said refrigerator and said pantry and the shelf life of each of the food items, said analysis program associated with each of said plurality of personal electronic devices analyzing data received from said extrinsic communication network wherein each of said plurality of personal electronic devices is configured to track the shelf life of each of the food items that are stored in said refrigerator and said pantry, said analysis program associated with each of said plurality of personal electronic devices generating an alert when said analysis program associated with each of said plurality of personal electronic devices determines that a shelf life has expired wherein said plurality of personal electronic devices is configured to notify a user that a food item has expired.

2. The device according to claim 1, wherein each of said plurality of scanners comprises:
a housing having a top wall and a bottom wall;
an adhesive layer being applied to said top wall thereby facilitating said adhesive layer to adhere to said refrigerator or said pantry for attaching said housing to said refrigerator or said pantry; and
a protective sheet being removably applied to an exposed surface of said adhesive layer such that said protective sheet inhibits said adhesive layer from being adhered.

3. The device according to claim 2, wherein each of said plurality of scanners includes:
a processor being integrated into said housing; and
a bar code reader being integrated into said bottom wall of said housing wherein said bar code reader is configured to emit infra-red light for reading a bar code, said bar code reader being electrically coupled to said processor.

4. The device according to claim 3, wherein each of said scanners includes a transmitter being integrated into said housing such that said transmitter defines said communication unit, said transmitter being electrically coupled to said processor, said transmitter being in wireless communication with said extrinsic communication network, said transmitter receiving data from said bar code reader thereby facilitating said transmitter to broadcast said data to said extrinsic communication network.

5. The device according to claim 3, wherein each of said scanners includes a power supply being integrated into said housing, said power supply being electrically coupled to said processor, said power supply comprising:
a battery being positioned within said housing, said battery being electrically coupled to said processor; and
a power button being movably integrated into said housing, said power button being electrically coupled to said processor for actuating and de-actuating said processor when said power button is depressed.

6. A food item tracking device for tracking the shelf life of food items being stored in a refrigerator or pantry, said device comprising:
a plurality of scanners, each of said plurality of scanners being mountable in a respective one of a refrigerator and a pantry wherein each of said plurality of scanners is configured to scan a barcode of a food item being removed from said refrigerator or said pantry, each of said plurality of scanners having a communication unit being in remote communication with an extrinsic communication network thereby facilitating each of said scanners to broadcast data to said extrinsic communication network wherein each of said scanners is configured to broadcast the shelf life of the food item to said extrinsic communication network, each of said plurality of scanners comprising:
a housing having a top wall and a bottom wall;
an adhesive layer being applied to said top wall thereby facilitating said adhesive layer to adhere to said refrigerator or said pantry for attaching said housing to said refrigerator or said pantry;
a protective sheet being removably applied to an exposed surface of said adhesive layer such that said protective sheet inhibits said adhesive layer from being adhered;
a processor being integrated into said housing;
a bar code reader being integrated into said bottom wall of said housing wherein said bar code reader is configured to emit infra-red light for reading a bar code, said bar code reader being electrically coupled to said processor;
a transmitter being integrated into said housing such that said transmitter defies said communication unit, said transmitter being electrically coupled to said processor, said transmitter being in wireless communication with said extrinsic communication network, said transmitter receiving data from said bar code reader thereby facilitating said transmitter to broadcast said data to said extrinsic communication network; and
a power supply being integrated into said housing, said power supply being electrically coupled to said processor, said power supply comprising:
a battery being positioned within said housing, said battery being electrically coupled to said processor; and
a power button being movably integrated into said housing, said power button being electrically coupled to said processor for actuating and de-actuating said processor when said power button is depressed; and
a plurality of personal electronic devices, each of said plurality of personal electronic devices being in remote communication with said extrinsic communication network such that each of said plurality of personal electronic devices receives data from said extrinsic communication network wherein each of said personal electronic devices is configured to receive the identity and the shelf life of the food item scanned by a respective scanner, each of said plurality of personal electronic devices storing an analysis program and a database which comprises data received from said extrinsic communication network wherein each of said plurality of personal electronic devices is configured to store a list of all of the food items that are stored in said refrigerator and said pantry and the shelf life of each of the food items, said analysis program associated with each of said plurality of personal electronic devices analyzing data received from said extrinsic communication network wherein each of said plurality of personal electronic devices is configured to track the shelf life of each of the food items that are stored in said refrigerator and said pantry, said analysis program associated with each of said plurality of personal electronic devices generating an alert when said analysis program associated with each of said plurality of personal electronic devices determines that a shelf life has expired wherein said plurality of personal electronic devices is configured to notify a user that a food item has expired.

7. A method of tracking expiration dates of food items in a refrigerator and a pantry, the steps of the method comprising:
loading an analysis program onto a personal electronic device which is in remote communication with an extrinsic communication network;
performing an initial scan a barcode on a food item with a scanner that is mounted in a refrigerator or a pantry thereby facilitating said scanner to broadcast data contained in the barcode to said personal electronic device via said extrinsic communication network for storing the name of the food item and the expiration date of the food item in said analysis program stored in said personal electronic device;
scanning the barcode on a food item with the scanner that is mounted in the refrigerator or the pantry when the food item is removed from the refrigerator or the panty for use;
scanning the barcode on the food item with the scanner that is mounted in the refrigerator or pantry when the food item is placed back in the refrigerator or pantry; and
replacing the food item in refrigerator or the pantry when said personal electronic device generates an alert as a result of said analysis program determining that the expiration date of the food item has passed.
